(19) United States
(12) Patent Application Publication
(10) Pub. No.: US 2009/0290996 A1
(43) Pub. Date: Nov. 26, 2009

(54) Bent Axis Type Variable Displacement Pump/Motor

(75) Inventor: Naoki Ishizaki, Tochigi (JP)

Correspondence Address: EDWARDS ANGELL PALMER & DODGE LLP, P.O. BOX 55874, BOSTON, MA, 02205, US

(73) Assignee: Komatsu Ltd, Tokyo (JP)

(21) Appl. No.: 12/085,178

(22) PCT Filed: Nov. 1, 2006
(86) PCT No.: PCT/JP2006/321900

§ 371 Date: May 19, 2008

(30) Foreign Application Priority Data
Nov. 24, 2005 (JP) 2005 339065

(51) Int. Cl. F04B 1/24; F03C 1/253

(52) U.S. Cl. 417/269; 91/499

(57) ABSTRACT

The present invention relates to an improvement of an bent axis type variable displacement pump/motor in which a piston moves reciprocatingly inside a cylinder and a state in which three parties of a cylinder block, a valve plate member, and a case are always in close contact with each other is secured by configuring the valve plate member with a plurality of valve plate parts comprising a first valve plate part and a second valve plate part and placing the valve plate member between a block side sliding surface of a cylinder block and a concave guide surface of the case while the plurality of valve plate parts are slidably brought into close contact with each other via sliding contact surfaces.

### TECHNICAL FIELD

The present invention relates to an bent axis type variable displacement pump/motor, and in particular, relates to an improvement of an bent axis type variable displacement pump/motor in which a piston moves reciprocatingly inside a cylinder.

### BACKGROUND ART

In a hydraulic system using a working fluid such as a pressure oil as a medium for power transmission, still better efficiency is demanded. In a variable displacement hydraulic pump or hydraulic motor in which a piston moves reciprocatingly inside a cylinder, a critical challenge is to construct a volume portion called a dead volume as small as possible to improve volumetric efficiency. That is, the dead volume is a volume portion secured inside the cylinder up to the piston when the piston is located at a maximal entry position (hereinafter, called a “top dead center position of the piston” when appropriate) with respect to the cylinder and is independent of volume change caused by reciprocation movement of the piston and thus, could cause lower volumetric efficiency. Particularly when the dead volume is constructed large, a pressure oil, which is originally an incompressible fluid, will induce a phenomenon equivalent to that induced by a compressible fluid in high-pressure conditions, making the aforementioned lower volumetric efficiency still more pronounced. In addition, even if the dead volume is set, for example, to be minimal in a state of a tilt angle at which the maximal reciprocal displacement of the piston is achieved, a large volume will be secured in a state of the tilt angle at which the minimal reciprocal displacement of the piston is achieved because, if the tilt angle decreases as the volume changes, the maximal entry amount of the piston will be smaller with the decreasing tilt angle.

Thus, for example, a technology disclosed by Patent Document 1 is conventionally provided. The technology described in Patent Document 1 causes a tilting center of a piston rod occupying the top dead center position to match with a tilting center of a swash plate. According to the technology described in Patent Document 1, the top dead center position of the piston with respect to the cylinder is always the same regardless of the tilt angle of the swash plate. Therefore, if configured in such a way that the dead volume becomes minimal in a state of the tilt angle at which the maximal reciprocal displacement of the piston is achieved, the dead volume can always be maintained minimal even if the tilt angle is changed to change the reciprocal displacement of the piston.

However, the technology disclosed in Patent Document 1 is a so-called swash plate type variable displacement pump/motor and it is difficult to apply the above configuration to maintain the dead volume constant unchanged to a bent axis type variable displacement pump/motor.

On the other hand, a technology disclosed in Patent Document 2 is provided as a conventional technology of bent axis type pump/motor. According to the technology disclosed in Patent Document 2, a convex circular surface protruding on a side opposite to a cylinder block in a valve plate member placed between the cylinder block and a case is a cylindrical surface whose axial center is an axis perpendicular to a plane containing an axial center of a shaft center and that of the cylinder block and the axial center of the cylindrical surface is at a position deviating in a tilting direction of the cylinder block from the axial center of the shaft member, more specifically, passes near the tilting center of a piston rod located at the top dead center position. A concave guide surface of the case with which the valve plate member is in sliding contact is formed to be a concave circular surface matching the convex circular surface.

According to the technology described in Patent Document 2, the top dead center position of the piston with respect to the cylinder is always approximately the same regardless of the magnitude of the tilt angle. Therefore, if configured in such a way that the dead volume becomes minimal in a state of the tilt angle at which the maximal reciprocal displacement of the piston is achieved, the dead volume can always be maintained at a small value even if the tilt angle is changed to change the reciprocal displacement of the piston.

Patent Document 1: Japanese Patent Application Laid-Open No. S58-77180

Patent Document 2: Japanese Patent Application Laid-Open No. H8-303342

### DISCLOSURE OF INVENTION

### Problem to be Solved by the Invention

In the above technology described in Patent Document 2, the shaft member and the cylinder block are linked by a center rod. When the cylinder block tilts, the shaft member is subject to an influence due to linkage to the center rod and also that of the valve plate member sliding along the concave guide surface of the case. The valve plate member sliding along the concave guide surface of the case, on the other hand, moves under the influence of only the concave guide surface. As a result of these, when the reciprocal displacement of the piston is changed, the relative orientation between the cylinder block and the valve plate member and movement magnitudes thereof will change and thus, there is a possibility that a gap arises between the cylinder block and the valve plate member or between the valve plate member and the case.

The valve plate member placed between the cylinder block and the case has a communicating oil groove for causing a pressure oil to flow between an oil groove provided in the cylinders of the cylinder block and that provided in the case. Therefore, when a gap arises between the cylinder block and the valve plate member or between the valve plate member and the concave guide surface of the case, as described above, it is difficult to cause a pressure oil to flow and, as a result, there is a possibility of a situation being invited in which volumetric efficiency is extremely degraded.

In view of the above circumstances, an object of the present invention is to provide a bent axis type variable displacement pump/motor capable of improving volumetric efficiency.

### Means for Solving Problem

To achieve the above object, a bent axis type variable displacement pump/motor according to claim 1 of the present invention comprises a shaft member which is supported by a case in a manner to rotate around an axial center thereof, a plurality of piston rods, each piston rod having a head bulb at a base end thereof and a piston at a tip thereof, is tiltably supported via each head bulb on an identical circumference around the axial center of the shaft member at one end of the shaft member, a cylinder block which includes a plurality of openings to house a plurality of cylinders on a side such that each cylinder is reciprocatingly movable in each opening while having a spherical block side sliding surface on the other end, a linking device for linking the cylinder block and the shaft member in such a manner that the axial center of the cylinder block is tiltable around a tilting point set on the axial center of the shaft member, the cylinder block is movable approaching/departing from the shaft member, and for pressing the cylinder block toward the other direction of the shaft member, a concave guide surface constituting a cylindrical concave shape which is positioned on a plane perpendicular to the axial center of the shaft member and whose axial center is an axis in a twisted spatial relationship with the axial center of the shaft member, the concave guide surface being formed at a site on an extension line from one end of the shaft member, a valve plate member placed between a block side sliding surface of the cylinder block and the concave guide surface of the case and having a communicating oil groove for causing a pressure oil to flow between an oil groove provided in the cylinders of the cylinder block and that provided in the case, and a oscillation angle controlling device for changing a reciprocal displacement of the piston when the shaft member and the cylinder block rotate by tilting the cylinder block with respect to the shaft member. The valve plate member includes a plurality of valve plate parts comprising at least a first valve plate part having a valve plate side sliding surface to be slidable when in close contact with the block side sliding surface and a second valve plate part having a convex guide surface to be slidable when in close contact with the concave guide surface, and is placed between the block side sliding surface of the cylinder block and the concave guide surface of the case while the plurality of valve plate parts are slidably brought into close contact with each other via sliding contact surfaces.

A bent axis type variable displacement pump/motor according to claim 2 of the present invention is characterized in that the concave guide surface is a cylindrical surface whose axial center is a tangent of a circumference passing through tilting centers of the plurality of piston rods in the aforementioned claim 1.

A bent axis type variable displacement pump/motor according to claim 3 of the present invention is characterized in that the first valve plate part and the second valve plate part are in close contact with each other via a cylindrical sliding contact surface whose axial center is an axis in parallel with the axial center of the concave guide surface in the aforementioned claim 1.

A bent axis type variable displacement pump/motor according to claim 4 of the present invention is characterized in that the sliding contact surface has an axial center perpendicular to that of the cylinder block in the aforementioned claim 3.

A bent axis type variable displacement pump/motor according to claim 5 of the present invention is characterized in that a convex sliding contact surface is formed for the first valve plate part and a concave sliding contact surface is formed for the second valve plate part in the aforementioned claim 3.

A bent axis type variable displacement pump/motor according to claim 6 of the present invention is characterized in that a concave sliding contact surface is formed for the first valve plate part and a convex sliding contact surface is formed for the second valve plate part in the aforementioned claim 3.

### EFFECT OF THE INVENTION

According to the present invention, a valve plate member is formed of a plurality of valve plate parts comprising at least a first valve plate part and a second valve plate part, and the plurality of valve plate parts in a state in which the plurality of valve plate parts are slidably brought in close contact with each other via a sliding contact surface are placed between a block side sliding surface of a cylinder block and a concave guide surface of a case. Therefore, if the tilt angle is changed, a state in which three parties of the cylinder block, valve plate member, and case are in close contact with each other can be maintained by the plurality of valve plate parts being slid appropriately. Accordingly, there is no possibility of causing a leak of pressure oil from among the three parties of the cylinder block, valve plate member, and case. In addition, settings can be made so that the top dead center position of a piston with respect to a cylinder is always approximately the same regardless of the magnitude of the tilt angle. Therefore, if configured in such a way that the dead volume becomes minimal in a state of the tilt angle at which the maximal reciprocal displacement of the piston is achieved, the dead volume can always be maintained at a small value even if the tilt angle is changed to change the reciprocal displacement of the piston, allowing improvement of volumetric efficiency.

### BRIEF DESCRIPTION OF DRAWINGS

FIG. 1 is a sectional view conceptually showing a structure of a state in which a bent axis type variable displacement pump/motor according to a first embodiment of the present invention is at a maximal tilt angle;

FIG. 2 is a sectional view showing a flow system of pressure oil in a state in which the bent axis type variable displacement pump/motor shown in FIG. 1 is at the maximal tilt angle;

FIG. 3 is a sectional view conceptually showing the structure of a state in which the bent axis type variable displacement pump/motor shown in FIG. 1 is at a minimal tilt angle;

FIG. 4 is a sectional view showing the flow system of the pressure oil in a state in which the bent axis type variable displacement pump/motor shown in FIG. 1 is at the minimal tilt angle;

FIG. 5 is a sectional view of along the line 5-5 in FIG. 1;

FIG. 6 is a sectional view of along the line 6-6 in FIG. 1;

FIG. 7 is a view showing one facet of a first valve plate part applied to the bent axis type variable displacement pump/motor shown in FIG. 1;

FIG. 8 is a view showing another facet of the first valve plate part applied to the bent axis type variable displacement pump/motor shown in FIG. 1;

FIG. 9 is a view showing one facet of a second valve plate part applied to the bent axis type variable displacement pump/motor shown in FIG. 1;

FIG. 10 is a view showing another facet of the second valve plate part applied to the bent axis type variable displacement pump/motor shown in FIG. 1;

FIG. 11 is a sectional view conceptually showing the structure of a state in which a bent axis type variable displacement pump/motor according to a second embodiment of the present invention is at the maximal tilt angle; and

FIG. 12 is a sectional view conceptually showing the structure of a state in which the bent axis type variable displacement pump/motor shown in FIG. 11 is at the minimal tilt angle.

### EXPLANATIONS OF LETTERS AND NUMERALS

1 bent axis type variable displacement pump/motor
10 case
10A accommodation space
11 case body part
12 plate part
13 concave guide surface
13A axial center
14 oil groove
20 shaft member
21 bearing
22 axial center
23 drive disk
30 cylinder block
31 bearing hole
32 cylinder
33 block side sliding surface
34 axial center
35 pressing spring
36 connection passage
40 piston rod
41 head bulb
42 piston
43 sealing member
50 center rod
51 head bulb
51A center
52 sliding part
60 valve plate member
61 first valve plate part
62 second valve plate part
63 valve plate side sliding surface
64 convex guide surface
65 convex sliding contact surface
66 concave sliding contact surface
67 stopper surface
70 first communicating oil groove
71 valve plate side port
72 first connection port
80 second communicating oil groove
81 second connection port
82 case side port
90 oscillation pin
91 oscillation angle control piston
92 return spring
93 pressure chamber
94 valve
160 valve plate member
161 first valve plate part
162 second valve plate part
165 convex sliding contact surface
166 concave sliding contact surface
C1 circumference
C2 circumference
X tilt reference plane

### BEST MODES FOR CARRYING OUT THE INVENTION

Preferred embodiments of a bent axis type variable displacement pump/motor according to the present invention will be described below in detail with reference to attached drawings.

### First Embodiment

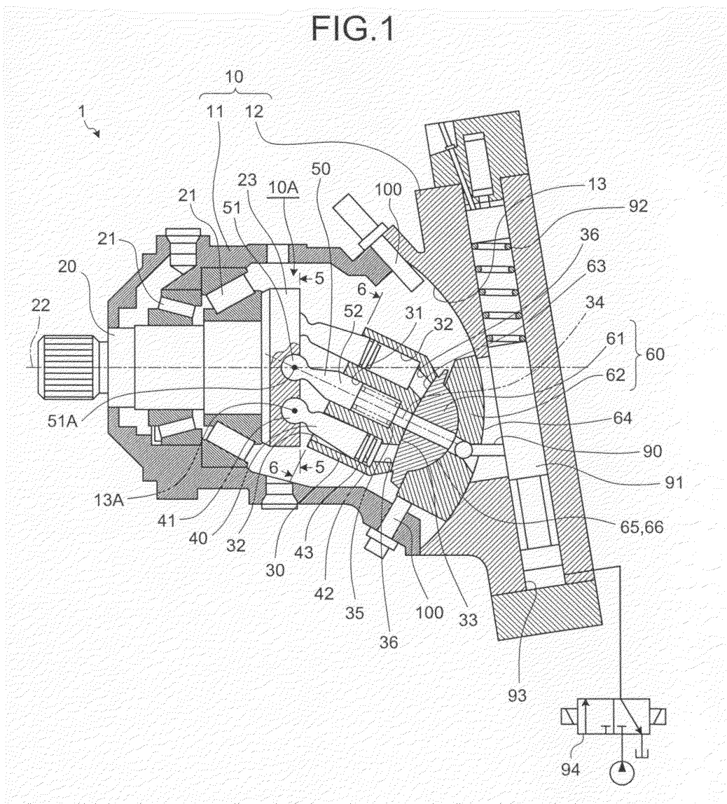

FIGS. 1 to 4 show a bent axis type variable displacement pump/motor according to a first embodiment of the present invention and exemplifies a bent axis type variable displacement pump/motor 1 mounted in a construction machine such as a hydraulic excavator and a wheel loader as a hydraulic rotating machine.

A case 10 of the pump/motor 1 comprises a case body part 11 having an accommodation space 10A whose one end is open and a plate part 12 mounted at one end of the case body part 11 in such a manner that the open end of the accommodation space 10A is closed, and the accommodation space 10A houses a shaft member 20 and a cylinder block 30.

The shaft member 20 functions as an input shaft when used as a pump and as an output shaft when used as a motor, is supported by the case body part 11 via a bearing 21 provided for radial load and trust load, and is capable of rotating around an axial center 22 of itself. As is evident from these figures, a base end of the shaft member 20 protrudes out of the case 10 and functions as an input/output end of the pump/motor 1.

A drive disk 23 is provided at an end of the shaft member 20 positioned inside the accommodation space 10A. The drive disk 23 is a plate-shaped part forming a disk around the axial center 22 of the shaft member 20 and comprises a plurality of piston rods 40 and a single center rod (linking means) 50 at a facet thereof.

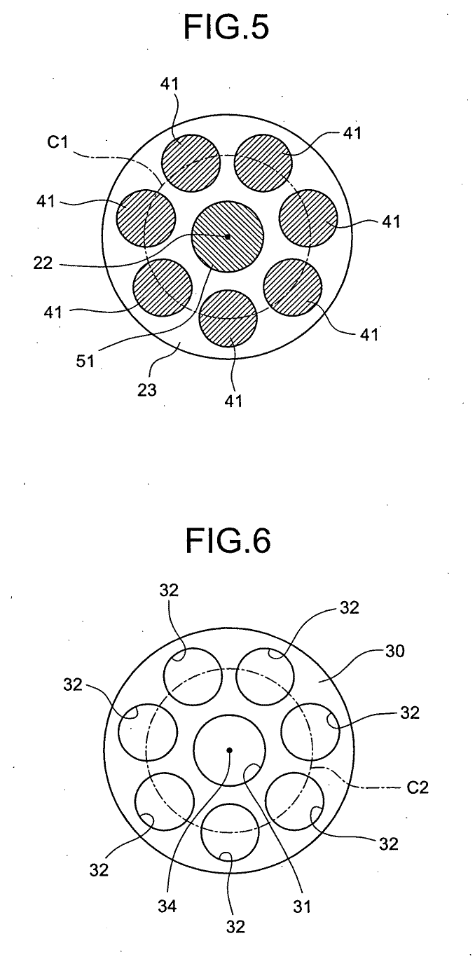

The piston rod 40 forms a tapered shape in which an outside diameter thereof gradually increases from the base end to a tip part thereof and constitutes a piston 42 at the tip part while having a spherical head bulb 41 acting as a supporter at the base end. As shown in FIG. 5, the piston rods 40 are made to be supported via the individual head bulbs 41 formed in such a manner that the individual head bulbs 41 are at sites on an identical circumference C1 around the axial center 22 of the shaft member 20 in the drive disk 23 at equal intervals and are capable of tilting in any direction around the center of each of the head bulbs 41 as the tilting center. As shown in FIGS. 1 to 4, each of the pistons 42 has a sealing member 43 mounted on an outer circumferential part thereof.

The center rod 50 forms a tapered shape in which the outside diameter thereof gradually increases from the base end to the tip part thereof and constitutes a cylindrical sliding part 52 at the tip part while having a spherical head bulb 51 at the base end. The center rod 50 is made to be supported via the head bulb 51 at a site on the axial center 22 of the shaft member 20 in the drive disk 23 and is capable of tilting in any direction around the center of the head bulb 51 positioned on the axial center 22 of the shaft member 20 as the tilting center.

The cylinder block 30 is a columnar member whose external shape is circular and is open for a single bearing hole 31 and a plurality of cylinders 32 at one end formed flat while having a block side sliding surface 33 at another end.

The bearing hole 31 is a cylindrical hole having an inside diameter being fitted into by the cylindrical sliding part 52 of the center rod 50 and is formed in such a manner that the axial center thereof is caused to match an axial center 34 of the cylinder block 30. The cylindrical sliding part 52 of the center rod 50 is slidably fitted into the bearing hole 31 in such a manner that the cylindrical sliding part 52 of the center rod 50 moves inside the bearing hole 31 in an axial direction while a pressing spring (linking means) 35 is placed.

Each of the cylinders 32 is a cylindrical hole having the inside diameter being fitted into by the piston 42 of the piston rod 40 and is formed so that the axial center thereof is parallel with the axial center 34 of the cylinder block 30. These cylinders 32 are prepared in the number equal to that of the piston rods 40 and, as shown in FIG. 6, are formed in such a manner that the individual axial centers are at sites on an identical circumference C2 around the axial center 34 of the cylinder block 30 at equal intervals. The distance from the axial center 34 of the cylinder block 30 to the axial center of the cylinder 32 is equal to that from the axial center 22 of the shaft member 20 to the center of the head bulb 41 of the piston rod 40 and the piston 42 of the piston rod 40 is reciprocatingly movably accommodated in each of the cylinders 32. As is evident from FIGS. 1 to 4, the piston rod 40 formed in a tapered shape is capable of tilting with respect to the center of the cylinder 32 while maintaining a state of close contact between the sealing member 43 of the piston 42 and an inner wall surface of the cylinder 32.

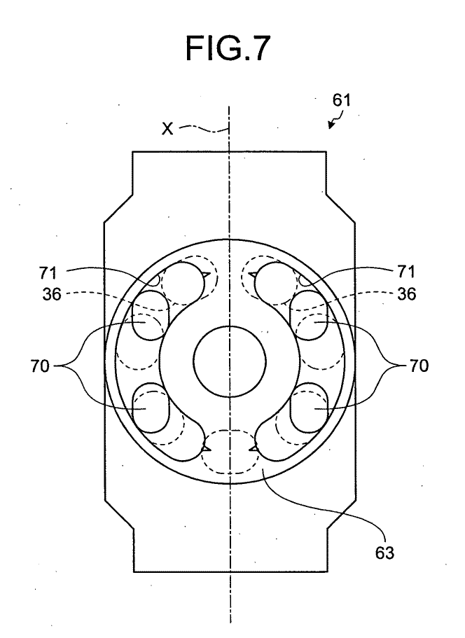

The block side sliding surface 33 is a spherical concave surface around a point positioned on an extension line from the axial center 34 of the cylinder block 30. The block side sliding surface 33 is provided with an opening which connects with each of connection passages 36 having the other opening connecting with the cylinder 32. The openings at the other end of the connection passages 36 are provided in such a manner that they are on a circumference around the axial center 34 of the cylinder block 30 at equal intervals (See FIG. 7).

In the pump/motor 1, on the other hand, a concave guide surface 13 is formed on the side facing the accommodation space 10A of the plate part 12 of the case 10 and a valve plate member 60 is provided between the case 10 and the cylinder block 30.

The concave guide surface 13 constitutes a cylindrical concave shape of which an axial center 13A is a tangent of the circumference C1 passing through the tilting center of each of the piston rods 40 and is formed at a site including an area on an extension line from one end of the shaft member 20. The tangent of the circumference C1 to be the axial center 13A of the concave guide surface 13 is positioned on a plane perpendicular to the axial center 22 of the shaft member 20 and also in a twisted spatial relationship with the axial center 22 of the shaft member 20.

The valve plate member 60 is placed between the block side sliding surface 33 of the cylinder block 30 and the concave guide surface 13 of the case 10 and, as shown in FIGS. 7 to 10, comprises a first valve plate part 61 positioned on the side of the cylinder block 30 and a second valve plate part 62 positioned on the side of the case 10.

The first valve plate part 61 has a valve plate side sliding surface 63 at a site opposite to the cylinder block 30 and is brought into contact with the block side sliding surface 33 via the valve plate side sliding surface 63. The valve plate side sliding surface 63 is a spherical convex surface having the same radius of curvature as the block side sliding surface 33 and can be slid in such a manner that the valve plate side sliding surface 63 relatively rotates around the axial center 34 of the cylinder block 30 while in close contact with the block side sliding surface 33.

The second valve plate part 62 has a convex guide surface 64 at a site opposite to the case 10 and is brought into contact with the concave guide surface 13 via the convex guide surface 64. The convex guide surface 64 is a cylindrical convex surface having the same radius of curvature as the concave guide surface 13 and can be slid along a curving direction of the concave guide surface 13 while in close contact with the concave guide surface 13.

These first valve plate part 61 and second valve plate part 62 are mutually brought into contact via sliding contact surfaces 65 and 66 slidably. The sliding contact surfaces 65 and 66 are cylindrical surfaces in parallel with the axial center 13A of the concave guide surface 13 and having an axis at right angles with the axial center 34 of the cylinder block 30 as an axial center, and are capable of sliding along the curving direction thereof while mutually in close contact. In the first embodiment, while a convex sliding contact surface (hereinafter, referred to as the “convex sliding contact surface 65”) is formed for the first valve plate part 61, a concave sliding contact surface (hereinafter, referred to as the “concave sliding contact surface 66”) is formed for the second valve plate part 62.

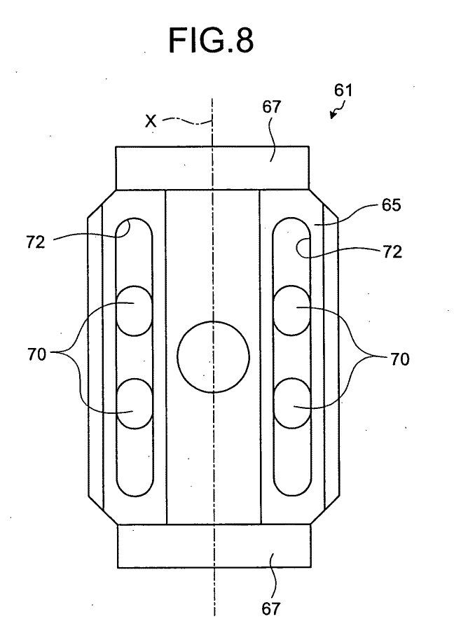

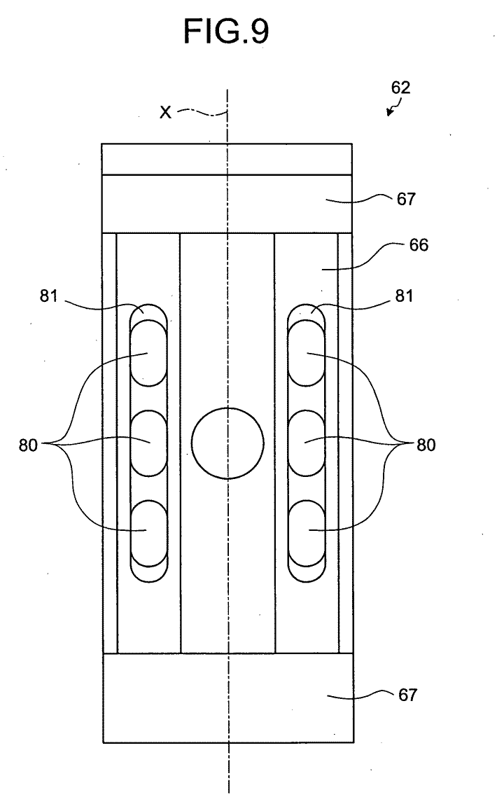

As shown in FIGS. 8 and 9, a stopper surface 67 is formed each at a site outside a formation area of the convex sliding contact surface 65 in the first valve plate part 61 and at a site outside a formation area of the concave sliding contact surface 66 in the second valve plate part 62. These stopper surfaces 67 regulate the range of sliding along the curving direction of the convex sliding contact surface 65 and the concave sliding contact surface 66 by parties opposite to each other coming into contact in an alternative way.

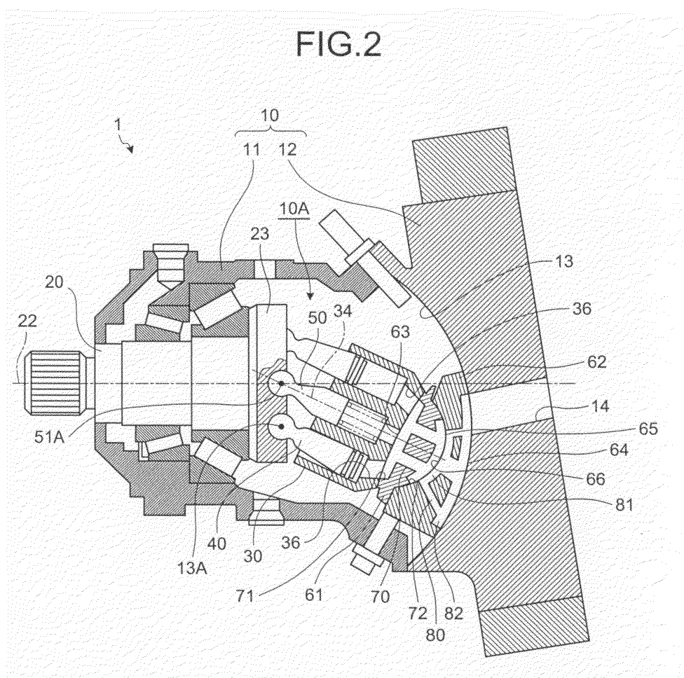

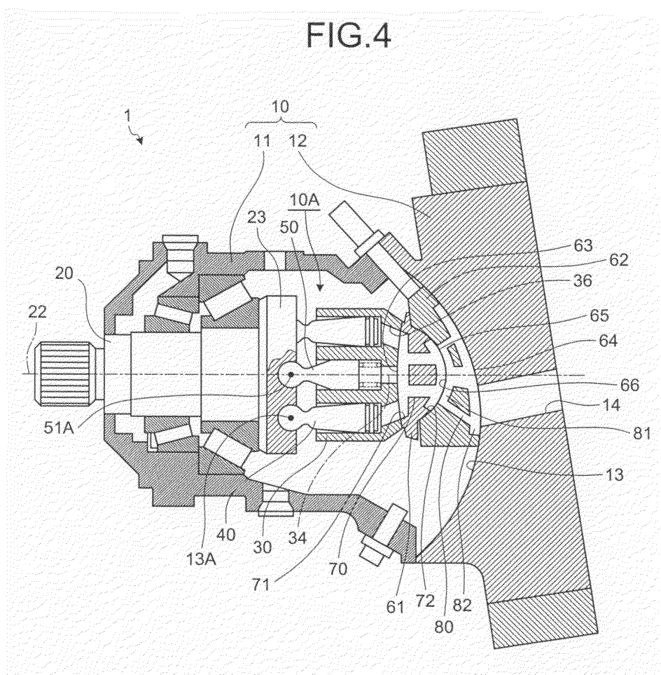

As is shown in FIGS. 2 and 4, the first valve plate part 61 and the second valve plate part 62 are respectively provided with communicating oil grooves 70 and 80 to cause a pressure oil to flow between an oil groove 14 provided in the cylinder 32 of the cylinder block 30 and that provided in the case 10.

The communicating oil groove (hereinafter, referred to as the “first communicating oil groove 70”) formed in the first valve plate part 61 causes a pressure oil to flow between the valve plate side sliding surface 63 and the convex sliding contact surface 65. While one end of the communicating oil groove is open to the valve plate side sliding surface 63 via a pair of valve plate side ports 71, another end thereof is open to the convex sliding contact surface 65 via a pair of first connection ports 72.

As shown in FIG. 7, the pair of valve plate side ports 71 is semicircular hollows formed to be symmetric with respect to a plane (the same plane as the page surface in FIG. 2 and hereinafter, referred to as the “tilting reference plane X”) perpendicular to the axial center 13A of the concave guide surface 13 and including the axial center 34 of the cylinder block 30 and is formed in such a manner to be open to a site corresponding to the connection passage 36 of the cylinder block 30 on the valve plate side sliding surface 63.

As shown in FIG. 8, the pair of first connection ports 72 is hollows, each extending along an extending direction of the tilting reference plane X and formed to be symmetric with respect to the tilting reference plane X.

The communicating oil groove (hereinafter, referred to as the “second communicating oil groove 80”) formed in the second valve plate part 62 causes a pressure oil to flow between the concave sliding contact surface 66 and the convex guide surface 64, and while one end thereof is open to the concave sliding contact surface 66 via a pair of second connection ports 81, another end thereof is open to the convex guide surface 64 via a pair of case side ports 82.

As shown in FIG. 9, the pair of second connection ports 81 is hollows, each extending along the extending direction of the tilting reference plane X and formed to be symmetric with respect to the tilting reference plane X.

These second connection ports 81 are formed in such a way that the second connection ports 81 face each other when the convex sliding contact surface 65 of the first valve plate part 61 is brought into close contact with the concave sliding contact surface 66 of the second valve plate part 62 and are always communicatively connected without being exposed to the outside when the concave sliding contact surface 66 and the convex sliding contact surface 65 are slid.

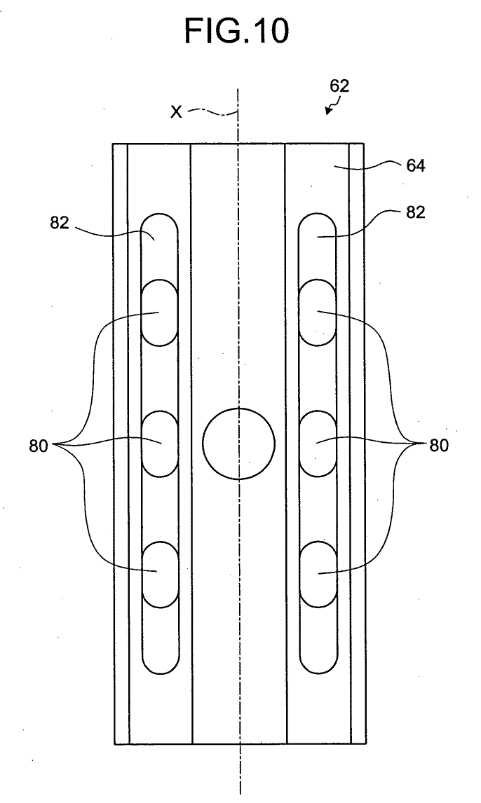

As shown in FIG. 10, the pair of case side ports 82 is hollows, each extending along the extending direction of the tilting reference plane X and formed to be symmetric with respect to the tilting reference plane X. As shown in FIGS. 2 and 4, these case side ports 82 are formed in such a way that the case side ports 82 face each other when the convex guide surface 64 of the second valve plate part 62 is brought into close contact with the concave guide surface 13 of the case 10 and are always communicatively connected without being exposed to the outside when the concave guide surface 13 and the convex guide surface 64 are slid.

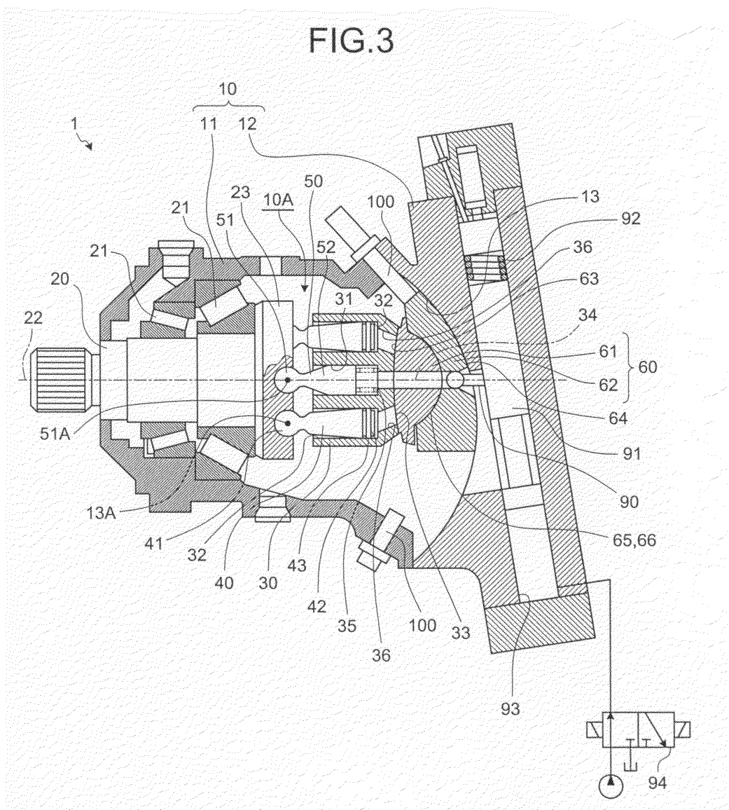

Further, an oscillation angle control piston (tilt angle changing means) 91 is tiltably connected to the second valve plate part 62 via an oscillation pin 90. The oscillation angle control piston 91 occupies an initial position by spring force of a return spring 92 in a normal condition to maintain the second valve plate part 62 in a state shown in FIG. 1. When pressure oil is supplied to a pressure chamber 93 formed in the case 10 via a valve 94, the oscillation angle control piston 91 moves along the tilting reference plane X against the spring force of the return spring 92 to cause the second valve plate part 62 to transition to a state shown in FIG. 3. Incidentally, reference numeral 100 in FIG. 1 is a defining member for defining the range of sliding of the second valve plate part 62 with respect to the concave guide surface 13 of the case 10.

In the pump/motor 1 configured as described above, when the oscillation angle control piston 91 is caused to occupy the initial position, as shown in FIG. 1, the cylinder block 30 is in the most tilted state around a center 51A of the head bulb 51 of the center rod 50 with respect to the axial center 22 of the shaft member 20. Therefore, if the shaft member 20 and the cylinder block 30 are rotated around the respective axial centers 22 and 34, the reciprocal displacement of the piston 42 will be maximal so that an operation can be performed in a maximum volume state.

If a pressure oil is supplied to the pressure chamber 93 of the case 10 in the aforementioned state to cause the oscillation angle control piston 91 to move against the spring force of the return spring 92, the second valve plate part 62 slides along the concave guide surface 13 of the case 10 via the oscillation pin 90. Movement of the second valve plate part 62 causes the first valve plate part 61 to move via the concave sliding contact surface 66 and the convex sliding contact surface 65 mutually in contact and further causes the cylinder block 30 to move via the valve plate side sliding surface 63 and the block side sliding surface 33 mutually in contact. Consequently, the cylinder block 30 is successively tilted around the center 51A of the head bulb 51 of the center rod 50, reducing the tilt angle of the axial center 34 of the cylinder block 30 with respect to the axial center 22 of the shaft member 20. If, in this state, the shaft member 20 and the cylinder block 30 are rotated around the respective axial centers 22 and 34, the reciprocal displacement of the piston 42 will be reduced compared with the state shown in FIG. 1 so that an operation can be performed in a reduced volume state.

If the oscillation angle control piston 91 is further caused to move against the spring force of the return spring 92, the axial center 34 of the cylinder block 30 matches with the axial center 22 of the shaft member 20 in the end, transitioning to the state shown in FIG. 3. In this state, when the shaft member 20 and the cylinder block 30 are rotated around the respective axial centers 22 and 34, the reciprocal displacement of the piston 42 will be zero.

If, on the other hand, a pressure oil is discharged from the pressure chamber 93 of the case 10, the oscillation angle control piston 91 moves toward the initial position by the spring force of the return spring 92, accompanied by movement of the second valve plate part 62, the first valve plate part 61, and cylinder block 30, so that the tilt angle of the cylinder block 30 with respect to the shaft member 20 can gradually be increased, that is, the volume of the pump/motor 1 can be increased by increasing the reciprocal displacement of the piston 42.

Henceforth, the pump/motor can be operated as the bent axis type variable displacement pump/motor 1 by performing the aforementioned operations when appropriate.

As shown in FIGS. 1 and 3, while these operations are performed, the second valve plate part 62 slides on the concave guide surface 13 of which the axial center 13A is a tangent of the circumference C1 passing through the tilting center of each of the piston rods 40, that is, moves along a cylindrical surface whose axial center 13A is an axis intersecting perpendicular to the tilting reference plane X and passing through the center of the head bulb 41 of the piston rods 40 which is located in the maximal entry position (hereinafter, called the “top dead center position of the piston” when appropriate) with respect to the cylinder 32. Therefore, the top dead center position of the piston 42 with respect to the cylinder 32 always remains the same regardless of the magnitude of the tilt angle. Consequently, as shown in FIG. 1, for example, if configured in such a way that the dead volume becomes minimal in a state of the tilt angle at which the maximal reciprocal displacement of the piston 42 is achieved, the dead volume can always be maintained at a small value even if the tilt angle is changed to change the reciprocal displacement of the piston 42, allowing improvement of volumetric efficiency.

In addition, according to the pump/motor 1 described above, the valve plate member 60 comprising the first valve plate part 61 and the second valve plate part 62 that are slidable when mutually in close contact is placed between the cylinder block 30 and the case 10. Further, the spring force of the pressing spring 35 placed between the center rod 50 and the cylinder block 30 acts among the cylinder block 30, the valve plate member 60, and the case 10. Therefore, changes in relative orientation between the cylinder block 30 and the valve plate member 60 and movement magnitudes thereof that occur when the reciprocal displacement of the piston 42 is changed can be absorbed by relative sliding movement between the first valve plate part 61 and the second valve plate part 62. This allows to prevent a situation in which a gap arises between the cylinder block 30 and the valve plate member 60 or between the valve plate member 60 and the concave guide surface 13 of the case 10.

Consequently, as shown in FIGS. 2 and 4, a pressure oil can always be made to flow without leakage between the oil groove 14 in the cylinder 32 of the cylinder block 30 and that in the case 10 regardless of the magnitude of the tilt angle, and thus, there is no possibility of lower volumetric efficiency being caused by a leak of a pressure oil.

According to the pump/motor 1, as described above, the valve plate member 60 is configured to comprise the first valve plate part 61 and the second valve plate part 62, which is placed between the block side sliding surface 33 of the cylinder block 30 and the concave guide surface 13 of the case 10 while these valve plate parts 61 and 62 are mutually slidably brought into close contact via the sliding contact surfaces 65 and 66. Thus, when the tilt angle is changed, a state in which the three parties, the cylinder block 30, the valve plate member 60, and the case 10 are mutually in close contact can be maintained by these valve plate parts 61 and 62 being slid if necessary. Accordingly, there is no possibility of causing a leak of pressure oil from among the three parties of the cylinder block 30, the valve plate member 60, and the case 10. In addition, the top dead center position of the piston 42 with respect to the cylinder 32 remains the same regardless of the magnitude of the tilt angle. Therefore, if configured in such a way that the dead volume becomes minimal in a state of the tilt angle at which the maximal reciprocal displacement of the piston 42 is achieved, the dead volume can always be maintained at a small value even if the tilt angle is changed to change the reciprocal displacement of the piston 42, allowing improvement of volumetric efficiency.

In the first embodiment, a cylindrical surface whose axial center 13A is a tangent of the circumference C1 passing through the tilting centers of a plurality of piston rods 40 is selected as the concave guide surface 13. In other words, the concave guide surface 13 is configured whose axial center 13A is an axis passing through the tilting centers of the piston rods 40 perpendicular to the tilting reference plane X and located at the top dead center position. Therefore, the top dead center position of the piston 42 with respect to the cylinder 32 can be made the same regardless of the magnitude of the tilt angle. However, the present invention is not limited to this. For example, if the axial center 13A of the concave guide surface 13 is a cylindrical concave shape positioned on a plane perpendicular to the axial center 22 of the shaft member 20 and also in a twisted spatial relationship with the axial center 22 of the shaft member 20, the axial center 13A may be formed at any other site.

Also in the first embodiment, the valve plate member 60 is configured to comprise only the first valve plate part 61 and the second valve plate part 62, but the same operation effect can be achieved by forming a valve plate member comprising three or more valve plate parts.

### Second Embodiment

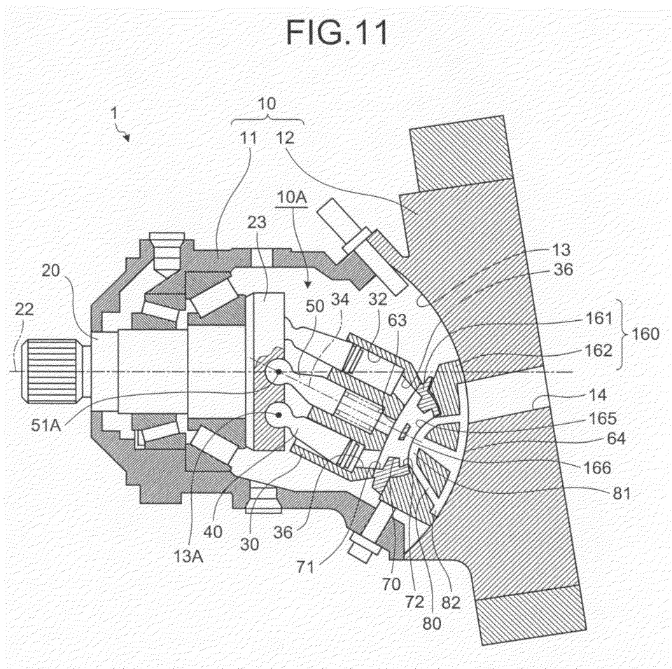

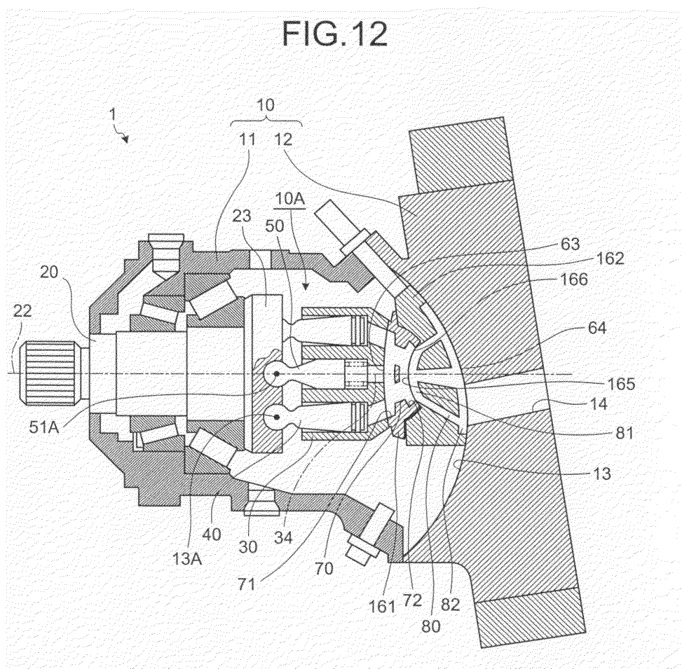

In the first embodiment, while the convex sliding contact surface 65 is formed on the first valve plate part 61, the concave sliding contact surface 66 is formed on the second valve plate part 62. However, like the second embodiment shown in FIGS. 11 and 12, while a concave sliding contact surface 166 may be formed on a first valve plate part 161 of a valve plate member 160, a convex sliding contact surface 165 may be formed on a second valve plate part 162 of the valve plate member 160. These concave sliding contact surface 166 and convex sliding contact surface 165 are cylindrical surfaces in parallel with the axial center 13A of the concave guide surface 13 and having an axis at right angles with the axial center 34 of the cylinder block 30 as an axial center, and are capable of sliding along the curving direction thereof while mutually in close contact. In FIGS. 11 and 12, the same reference numerals are attached to the same components as those in the first embodiment and a detailed description thereof is omitted.

When the pump/motor 1 configured as described above is in a state shown in FIG. 11, the cylinder block 30 is in the most tilted state around the center 51A of the head bulb 51 of the center rod 50 with respect to the axial center 22 of the shaft member 20. Therefore, if the shaft member 20 and the cylinder block 30 are rotated around the respective axial centers 22 and 34, the reciprocal displacement of the piston 42 will be maximal so that an operation can be performed in a maximum volume state.

If tilt angle changing means (not shown) is driven in the above state and a second valve plate part 162 is caused to slide along the concave guide surface 13 of the case 10, movement of the second valve plate part 162 causes the first valve plate part 161 to move via the convex sliding contact surface 165 and the concave sliding contact surface 166 mutually in contact. Further, movement of the first valve plate part 161 causes the cylinder block 30 to move via the valve plate side sliding surface 63 and the block side sliding surface 33 mutually in contact so that the cylinder block 30 is successively tilted around the center 51A of the head bulb 51 of the center rod 50, reducing the tilt angle of the axial center 34 of the cylinder block 30 with respect to the axial center 22 of the shaft member 20. If, in this state, the shaft member 20 and the cylinder block 30 are rotated around the respective axial centers 22 and 34, the reciprocal displacement of the piston 42 will be reduced compared with the state shown in FIG. 11 so that an operation can be performed in a reduced volume state.

If the second valve plate part 162 is further caused to move, the axial center 34 of the cylinder block 30 matches with the axial center 22 of the shaft member 20 in the end, transitioning to the state shown in FIG. 12. In this state, when the shaft member 20 and the cylinder block 30 are rotated around the respective axial centers 22 and 34, the reciprocal displacement of the piston 42 will also be zero.

If, on the other hand, the second valve plate part 162 is caused to move in an opposite direction by driving tilt angle driving means (not shown), the first valve plate part 161 and the cylinder block 30 will move together so that the tilt angle of the cylinder block 30 with respect to the shaft member 20 can gradually be increased, that is, the volume of the pump/motor 1 can be increased by increasing the reciprocal displacement of the piston 42.

Henceforth, the pump/motor can be operated as the bent axis type variable displacement pump/motor 1 by performing the aforementioned operations when appropriate.

As shown in FIGS. 11 and 12, while these operations are performed, the second valve plate part 162 slides on the concave guide surface 13 of which the axial center 13A is a tangent of a circumference passing through the tilting center of each of the piston rods 40, that is, moves along a cylindrical surface whose axial center 13A is an axis being perpendicular to the tilting reference plane X and passing through the center of the head bulb 41 of the piston rods 40 located at the top dead center position Therefore, the top dead center position of the piston 42 with respect to the cylinder 32 remains the same regardless of the magnitude of the tilt angle. Consequently, as shown in FIG. 11, for example, if configured in such a way that the dead volume becomes minimal in a state of the tilt angle at which the maximal reciprocal displacement of the piston 42 is achieved, the dead volume can always be maintained at a small value even if the tilt angle is changed to change the reciprocal displacement of the piston 42, allowing improvement of volumetric efficiency.

In addition, according to the pump/motor 1 described above, the valve plate member 160 comprising the first valve plate part 161 and the second valve plate part 162 that are slidable when mutually in close contact is placed between the cylinder block 30 and the case 10. Further, the spring force of the pressing spring 35 placed between the center rod 50 and the cylinder block 30 acts among the cylinder block 30, the valve plate member 160, and the case 10. Therefore, changes in relative orientation between the cylinder block 30 and the valve plate member 160 and movement magnitudes thereof that occur when the reciprocal displacement of the piston 42 is changed can be absorbed by relative sliding movement between the first valve plate part 161 and the second valve plate part 162. This allows to prevent a situation in which a gap arises between the cylinder block 30 and the valve plate member 160 or between the valve plate member 160 and the case 10.

Consequently, a pressure oil can always be made to flow without leakage between the oil groove 14 in the cylinder 32 of the cylinder block 30 and that in the case 10 and thus, there is no possibility of lower volumetric efficiency being caused by a leak of a pressure oil.

### INDUSTRIAL APPLICABILITY

As described above, an bent axis type variable displacement pump/motor according to the present invention is useful for improving volumetric efficiency and particularly suitable for use as a hydraulic machine of a hydraulic system in which high efficiency is demanded.

1. A bent axis type variable displacement pump/motor, comprising:
a shaft member which is supported by a case in a manner to rotate around an axial center thereof;
a plurality of piston rods, each piston rod having a head bulb at a base end thereof and a piston at a tip thereof, is tiltably supported via each head bulb on an identical circumference around the axial center of the shaft member at one end of the shaft member;
a cylinder block which includes a plurality of openings to house a plurality of cylinders on a side such that the cylinder is reciprocatingly movable in each of the openings while having a spherical block side sliding surface on the other end;
a linking device for linking the cylinder block and the shaft member in such a manner that an axial center of the cylinder block is tiltable around a tilting point set on the axial center of the shaft member, the cylinder block is movable approaching/departing from the shaft member, and for pressing the cylinder block toward the other direction of the shaft member;
a concave guide surface constituting a cylindrical concave shape which is positioned on a plane perpendicular to the axial center of the shaft member and whose axial center is an axis in a twisted spatial relationship with the axial center of the shaft member, the concave guide surface being formed at a site on an extension line from one end of the shaft member;
a valve plate member placed between a block side sliding surface of the cylinder block and the concave guide surface of the case and having a communicating oil groove for causing a pressure oil to flow between an oil groove provided in the cylinders of the cylinder block and that provided in the case; and
a oscillation angle controlling device for changing a reciprocal displacement of the piston when the shaft member and the cylinder block rotate by tilting the cylinder block with respect to the shaft member, wherein
the valve plate member includes a plurality of valve plate parts comprising at least a first valve plate part having a valve plate side sliding surface to be slidable when in close contact with the block side sliding surface and a second valve plate part having a convex guide surface to be slidable when in close contact with the concave guide surface, and is placed between the block side sliding surface of the cylinder block and the concave guide surface of the case while the plurality of valve plate parts are slidably brought into close contact with each other via sliding contact surfaces.

2. The bent axis type variable displacement pump/motor according to claim 1, wherein the concave guide surface is a cylindrical surface whose axial center is a tangent of a circumference passing through tilting centers of the plurality of piston rods.

3. The bent axis type variable displacement pump/motor according to claim 1, wherein the first valve plate part and the second valve plate part are in close contact with each other via a cylindrical sliding contact surface whose axial center is an axis in parallel with the axial center of the concave guide surface.

4. The bent axis type variable displacement pump/motor according to claim 3, wherein the sliding contact surface has an axial center perpendicular to that of the cylinder block.

5. The bent axis type variable displacement pump/motor according to claim 3, wherein a convex sliding contact surface is formed for the first valve plate part and a concave sliding contact surface is formed for the second valve plate part.

6. The bent axis type variable displacement pump/motor according to claim 3, wherein a concave sliding contact surface is formed for the first valve plate part and a convex sliding contact surface is formed for the second valve plate part.
